(19) United States
(12) Patent Application Publication
(10) Pub. No.: US 2012/0158431 A1
(43) Pub. Date: Jun. 21, 2012

(54) METHODS AND APPARATUS TO SUPPORT DIAGNOSIS PROCESSES

(75) Inventor: Ramesh Balasubramaniam, Bangalore (IN)

(73) Assignee: General Electric Company, Schenectady, NY (US)

(21) Appl. No.: 13/041,668

(22) Filed: Mar. 7, 2011

(30) Foreign Application Priority Data
Dec. 16, 2010 (IN) 3856/CHE/2010

(51) Int. Cl. G06Q 50/00

(52) U.S. Cl. 705/3

(57) ABSTRACT

Methods and apparatus to support diagnosis processes are disclosed. An example apparatus includes a data extractor to extract information related to a life stage of a patient from clinical records associated with a patient; and a first interface to interact with a database storing information related to a plurality of hazardous event exposures, wherein interacting with the database comprises determining whether a first one of the hazardous event exposures stored in the database corresponds to the life stage of the patient.

### RELATED APPLICATION

This patent claims the benefit of Indian Patent Application No. 3856/CHE/2010, filed on Dec. 16, 2010, which is hereby incorporated herein in its entirety.

### FIELD OF THE DISCLOSURE

This disclosure relates generally to healthcare information systems and, more particularly, to methods and apparatus to support diagnosis processes.

### BACKGROUND

Healthcare environments, such as hospitals and clinics, typically include information systems (e.g., hospital information systems (HIS), radiology information systems (RIS), storage systems, picture archiving and communication systems (PACS), etc.) to manage clinical information such as, for example, patient medical histories, imaging data, test results, diagnosis information, management information, and/or scheduling information. The information may be centrally stored or distributed at a plurality of locations. Healthcare practitioners may desire to access patient information or other information at various points in a healthcare workflow. Medical practitioners, such as doctors, surgeons, and other medical professionals, rely on the clinical information stored in such systems to assess the condition of a patient, to obtain information related to a health history of the patient, to provide immediate treatment to a patient in an emergency situation, to diagnose a disease or condition of a patient, and/or to provide any other medical treatment or attention.

### SUMMARY

An example apparatus disclosed herein includes a data extractor to extract information related to a life stage of a patient from clinical records associated with a patient. The example apparatus also includes a first interface to interact with a database storing information related to a plurality of hazardous event exposures, wherein interacting with the database comprises determining whether a first one of the hazardous event exposures stored in the exposure database corresponds to the life stage of the patient.

An example method disclosed herein includes extracting information related to a life stage of a patient from clinical records associated with the patient. The example method also includes interacting with a database storing information related to a plurality of hazardous event exposures, wherein interacting with the database comprises determining whether one or more of the hazardous event exposures stored in the database corresponds to the life stage of the patient. The example method also includes, when a first one of the one or more hazardous event exposures corresponds to the life stage of the patient, displaying data related to the first hazardous event exposures on a display device.

An example system disclosed herein includes an exposure database to store events including actual or potential exposure of people to elements deemed to be hazardous to the people, wherein the exposure database stores characteristics of the events. The example system also includes a mappings storage to store a plurality of findings linking the hazardous elements to one or more health effects. The example system also includes a module to extract data related to a life stage of a patient from clinical records associated with the patient, the module to query the exposure database using the extracted data to determine whether one or more of the exposure events corresponds to the life stage of the patient and, wherein the module is to receive one or more of the findings from the mappings storage when the query of the exposure database indicates that at least one of the exposure events corresponds to the life stage of the patient.

### BRIEF DESCRIPTION OF THE DRAWINGS

FIG. 1 is a schematic illustration of an example clinical record system within which the example methods, apparatus, systems and articles of manufacture described herein may be implemented.

FIG. 2 is a block diagram of an example apparatus that may be used to implement the example exposure database of FIG. 1.

FIG. 3 is an example exposure diagram illustrating example manners in which people are exposed to hazardous materials.

FIG. 4 is an example table that may be stored by the example exposure database of FIGS. 1 and/or 2.

FIG. 5 is a block diagram of an example apparatus that may be used to implement the example diagnosis support module of FIG. 1.

FIG. 6 is a flow diagram representative of example machine-readable instructions that may be executed to implement the example diagnosis support module of FIGS. 1 and/or 5.

FIG. 7 is a block diagram of an example processor system that may be used to execute the machine-readable instructions of FIG. 6 and/or to implement the example diagnosis support module of FIGS. 1 and/or 5.

### DETAILED DESCRIPTION

Although the following discloses example methods, apparatus, systems, and articles of manufacture including, among other components, firmware and/or software executed on hardware, it should be noted that such methods, apparatus, and systems are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware implemented on-site and/or off-site via a network (e.g., an Internet space). Accordingly, while the following describes example methods, apparatus, systems, and/or articles of manufacture, the examples provided are not the only way(s) to implement such methods, apparatus, systems, and/or articles of manufacture.

Early detection of many diseases and their conditions increases the likelihood that healthcare practitioners can successfully treat the diseases or conditions. Accordingly, healthcare practitioners and researchers aim to identify or detect diseases and conditions as early as possible in the course of treatment of a patient. Many efforts to provide early detection or identification center on genetic information and the likelihoods that those with certain genetic make-ups will develop certain diseases and/or conditions. The success of these systems depends on various factors such as, for example, the genetic blueprint inherited by the patient from his or her parents, an ability to measure, analyze and associate diseases and/or conditions with a genetic profile, an ability to map such a connection, and/or additional factors depending on, for example, the diseases and/or conditions at stake.

In addition to studies and systems focused on genetic information, healthcare practitioners are focused on issues related to exposure to hazardous materials and/or events. There are strong and/or suggestive scientific evidences pointing to environmental hazards manifesting in various lifetime diseases such as asthma and other respiratory ailments through lung damage, cancer, impact on fetal brain and, therefore, the behavior and learning ability of, for example, children. For example, years of exposing children to the metal Lead in gasoline and paint has proved detrimental to fetal and child brain development potentially causing, for example, behavioral problems and learning disabilities.

Accordingly, there is a growing concern among healthcare providers regarding health of newborns and/or adults due to exposures to toxic hazards. Example exposures and materials include air contaminants due to industrial and motor vehicle emissions, industrial accidents leading to chemical and nuclear radiation exposures, industrial effluents from manufacturing and their poor treatment before disposal, use of toxic pesticides in agricultural produce, excessive consumption of drugs through medications, use of chemicals in human consumables, etc. In many instances, exposures are grave due to vulnerability of children to health hazards, which could range from life to lifestyle threatening. Fetal development takes place with constant exchange of chemical messages between the fetus and the mother. Exposures to toxic substances during fetal development can cause interference between these toxic substances and the chemical messages of development.

Several differences between adults and newborns lead to greater vulnerability in children (e.g., persons ranging from newborns to teenagers). For example, when a kilogram-to-kilogram of body weight between an adult and child is compared, a child will eat more food, drink more water, and breathe more air than an adult. Thus, any contamination in food, water or air will deliver a proportionally higher amount of hazard to a child when compared to an adult. Likewise, compared to an adult, the surface area in the lungs of a child is larger in proportion to the rest of the body of the child. Proportional to body mass, a child's brain is larger and receives about double the blood flow per unit weight compared to an adult. As another example difference, the rate of breathing is faster in a child than in an adult, and it elevates more often because children tend to be more active, especially outdoors and often during peak air pollution times, such as travelling to and from school during the morning and evening rush hours. As another example, infants, babies and toddlers crawl around with their hands in routine contact with floors, carpets or the ground outdoors. Children are often more exploratory than adults, and for babies and small children this exploration often includes putting their hands and objects in their mouths. Younger children regularly play with toys, drop toys, and then pick toys up and put the toys back in their mouths. As another example, children have strong food preferences. Children often want to eat a limited range of the same kind of foods, sometimes for days or even weeks at a time. Children also tend to consume much more milk than adults. Even if such foods are nutritious, contaminants therein may deliver higher exposures than would occur with a more varied diet. Two other exposure differences related to food intake are the nourishment received by babies in the womb through the placenta and during breastfeeding. As another example difference, children have a longer lifetime ahead of them than do adults. These longer lifetimes include more time for exposures to occur and for health problems to manifest. Exposure of children to persistent substances (e.g., substances that do not break down and often accumulate in body fat or bone) leads to build-up of ill health in the bodies of the children for a longer period of time.

There are also physiological differences between adults and children that can make children more vulnerable to hazardous substances. For example, digestive systems of children will often absorb foods and associated contaminants more efficiently than that of an adult. While this can be due to immaturity of the digestive systems, in children older than six months the efficient absorption is more a matter of young healthy systems that work very efficiently to absorb nutrients necessary for ongoing growth and development. Also, in infancy, skin is more permeable than in later life, allowing passage of substances through the skin into the bloodstream. Additionally, airways and lungs of children develop from the early years through adolescence, during which time exposure to toxic substances can overburden the respiratory system. These exposures can cause temporary symptoms, or can actually affect the physical development of lung tissue, such that the lungs are more susceptible to pollutants later in life. As another example, children tend to have a faster metabolism than adults. Consequently, children need to take in more oxygen per unit of body weight per minute to support growth and activity needs, which are driven by the higher metabolic rates of children.

Further, among children, differences in socio-economic status can contribute to different levels of vulnerability to exposures. For example, poverty may be a determinant of health and is also associated with greater likelihood and opportunities for environmental and hazardous exposures. A well-nourished mother is better able to carry a pregnancy to term successfully and the organs and systems in the body of a well-nourished child can function well and provide some protection from toxic substances and other health threats. Cigarette smoking in the home is a significant risk factor for children, including while in the womb. Environmental Tobacco Smoke (ETS) is associated with effects on the respiratory system, including the development of asthma and as a trigger in those who already have the disease. ETS is also associated with impacts on brain development and contains over forty known carcinogens. When other risk factors, such as poverty, are present, the risks of ETS can be compounded. Also, parents who work with toxic substances can contribute to “carry-home” exposures that can affect children. People with certain genetic polymorphisms (alternate forms of genes) can be more susceptible to harmful effects from environmental hazards than people who do not have the same genetic variants.

Further, exposures during childhood may not result in health effects until adulthood. If children are exposed to chemicals or radiation that have latent effects, such as with most carcinogens, there will be greater opportunity in children than in adults for these exposures to lead to negative effects later in life. An example of both of these situations is sunburns during childhood, which are known to increase the risk of skin cancer in adulthood. In addition to latent effects, some early exposures can cause permanent and irreversible damage, such as the effects of the metal Lead on brain development, or lifelong effects on lung function from early exposures to air pollution.

As a result of these and other factors, the advantages of taking precautionary measures with regard to childhood exposures to harmful materials, events, and/or exposures to harmful materials or events of expecting mothers are significant. However, the study and understanding of ailments caused by such exposures is complex and involves varying degrees of uncertainty. The complexity and uncertainty is due, at least in part, to problems related to control over related scientific experiments. However, the overall health of a populace and, as a result, the safety and economy of a population is affected by such exposures. Therefore, systems and methods that can improve and/or utilize systems focused on exposure of populations to hazardous materials are highly advantageous to healthcare systems and those populations in general.

The example methods, apparatus, systems and/or articles of manufacture disclosed herein increase the ability of healthcare practitioners to detect or identify diseases or conditions in patients and/or to detect or identify increased likelihoods that patients will develop those diseases or conditions in their immediate or later life. To do so, the examples disclosed herein maintain an exposure database including information related to events during which people were potentially or actually exposed to hazardous elements (e.g., contacted, ingested, inhaled harmful materials, witnessed traumatic events, etc.). The example exposure database described herein also includes information mapping certain hazardous elements to possible diseases and/or conditions tied to exposure to those hazardous elements via, for example, empirical evidence gathered from one or more studies. The mapping information of the examples disclosed herein can also include diagnostic tests required or suggested to confirm or rule out manifestation or development of the corresponding disease(s) or condition(s).

Generally, the example methods, apparatus, systems, and/or articles of manufacture disclosed herein compare data associated with a patient (e.g., birth place and date of birth, occupational information associated with parents of the patient and/or other data described in detail below) to data of the exposure database to determine whether the patient was exposed or may have been exposed to hazardous elements during, for example, critical times of development and growth of the patient (e.g., during pregnancy and/or during the first three years of life of the patient). If the examples methods, apparatus, systems and/or articles of manufacture disclosed herein reveal or determine that the patient was or may have been exposed to hazardous elements using the example exposure database disclosed herein, the mappings of exposure to diseases/conditions can be referenced by, for example, a physician or oncologist to identify potential diseases/conditions for which the patient has an increased likelihood of developing. Such information can support or assist in, for example, a diagnosis of a patient presenting certain symptoms, in a predictive diagnosis of a potential future condition, and/or in explaining a diagnosis and an underlying cause of the diagnosed disease or condition. Moreover, when the example analysis is performed as a precautionary measure, proactive diagnostics steps could be taken to assess the manifestation, or lack thereof, of the disease related to the exposure.

Additionally, the mappings of the example exposure database disclosed herein may be updated as additional information becomes available (e.g., via learned relationships between exposures and diseases). Medical researchers can utilize the mappings of the example exposure database disclosed herein to support and/or improve findings and/or analyses. Further, the examples disclosed herein can track the accuracy of predictions made using the example exposure database disclosed herein. Additional and alternative aspects and advantages of the example methods, apparatus, systems, and/or articles of manufacture disclosed herein are described herein and/or will be apparent in view of the descriptions herein.

In the interest of brevity and clarity, throughout the following disclosure references will be made to an example clinical records server 100. However, the methods, apparatus, systems and/or articles of manufacture disclosed herein to assist diagnosis processes may be implemented by and/or within any number and/or type(s) of additional and/or alternative clinical records systems, servers and/or client devices. Such additional and/or alternative systems, servers and/or client devices may be communicatively coupled via any number and/or type(s) of public and/or private networks, and/or may be located and/or implemented at any number and/or type(s) of different geographically locations. Further, any of the methods, apparatus and articles of manufacture described herein could be implemented by or within a clinical records access terminal and/or client device that is communicatively coupled to the example clinical records server 100. Further still, presentations, screens and/or user interfaces generated by an example work list presenter 105, which is described in detail below, may be presented at the clinical records server 100 and/or at a clinic records access terminal and/or client device communicatively coupled to the server 100. Moreover, the example diagnosis support module 105 may be implemented at any number and/or type(s) of clinical records access terminals and/or client devices communicatively coupled to a clinical records server such as the example clinical records server 100.

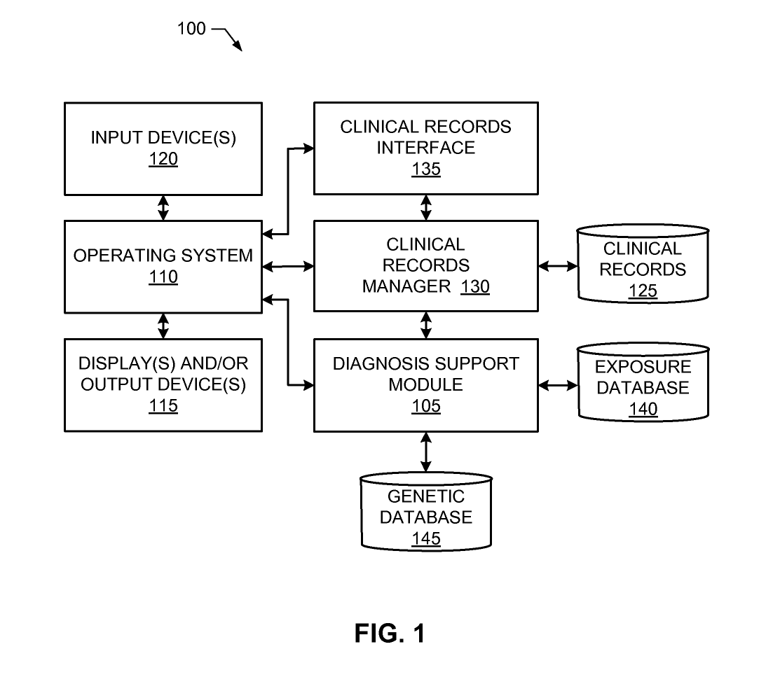

FIG. 1 illustrates the example clinical records server 100. To enable a user, such as a healthcare practitioner (e.g., a radiologists, a physician, a surgeon, an oncologist, a technician, an administrator, etc.) to interact with the example clinical records server 100, the clinical records server 100 of FIG. 1 includes an operating system 110, any number and/or type(s) of display(s) and/or output device(s) 115, and any number and/or type(s) of input device(s) 120. The example operating system 110 of FIG. 1 enables information (e.g., clinical records, medical records, test results, images, windows, screens, interfaces, dialog boxes, etc.) to be displayed at the display(s) and/or output device(s) 115, and to allow a user to control, configure and/or operate the example clinical records server 100 via the input device(s) 120. The user provides and/or makes inputs and/or selections via the input device(s) 120. Example input devices 120 include, but are not limited to, a keyboard, a touch screen, a trackball and/or a mouse, a microphone coupled to a voice recognition module, etc.

To manage patient and/or clinical records 125, the example clinical records server 100 of FIG. 1 includes a clinical records manager 130. The example clinical records manager 130 of FIG. 1 enables users via the operating system 110, the input device(s) 120, and/or the display(s) and/or output device(s) 115 to query and/or search for clinical records in the clinical records database 125. The example clinical records manager 130 also enables users via the operating system 110, the input device(s) 120, the display(s) and/or output device(s) 115 to add, create and/or modify clinical records in the database 125. In some examples, clinical records access terminals and/or client devices can access the clinical records database 125 via a clinical records interface or application programming interface 135 and the clinical records manager 130, and via any number and/or type(s) of private and/or public network(s). Patient and/or clinical records may be stored in the example clinical records database 125 using any number and/or type(s) of data structures, entries, tables and/or records. The example clinical records database 125 may be implemented by any number and/or type(s) of memory(-ies), memory device(s) and/or storage device(s).

The example clinical records database 125 may include and/or be in communication with additional record database(s) and may be capable of sharing data among the additional record database(s). For example, the example clinical records database 125 may be implemented as part of an Integrating the Healthcare Enterprise (IHE) Cross-Enterprise Document Sharing (XDS) integration profile, a health information exchange (HIE), a regional health information organization (RHIO), and/or any other system configured to facilitate sharing (e.g., registration, distribution, access, etc.) of healthcare data among the healthcare enterprises. Additionally or alternatively, the example clinical records database 125 may be implemented in a healthcare data system not having information sharing capabilities, such as a standalone physician office, a clinic or a hospital having a central data system.

The example clinical record server 100 of FIG. 1 also includes the example diagnosis support module 105. Generally, the example diagnosis support module 105 utilizes data maintained in an example exposure database 140 to provide insight into exposure events that may have affected one or more patients. In the illustrated example, the example diagnosis support module 105 compares data related to early stages of a patient's life (e.g., birth date and place of birth) to data stored in the example exposure database 140 related to recorded events during which people were or may have been exposed to hazardous materials. The example diagnosis support module 105 can analyze details of such a comparison to provide, for example, a basis or reason for one or more conditions or symptoms and/or a basis for precautionary measures to protect against possible development of one or more conditions or symptoms. For example, mappings maintained by the example exposure database 140 that link exposure to certain hazardous materials to certain diseases (e.g., cancers) can be and can be referenced by the example diagnosis support module 105. Such linking information can give a healthcare practitioner useful information to support an initial diagnosis, to screen patients for possible future conditions, to establish a reason to order one or more tests, and/or to otherwise provide improved care to a plurality of patients. Moreover, the example diagnosis support module 105 uses information stored in a genetic database 145 to provide healthcare practitioners additional information and support. For example, the diagnosis support module 105 can query the genetic database 145 to determine whether a lineage of a patient includes any indications that the patient may be prone to certain diseases or conditions. Moreover, data from the example genetic database 145 can be used alone or in combination with data from the exposure database 140 by a healthcare practitioner providing treatment to a patient (e.g., as part of an initialization of a patient-doctor relationship). The example diagnosis support module 105 and the example interactions thereof with the example exposure database 140 and the example genetic database 145 are described in greater detail below.

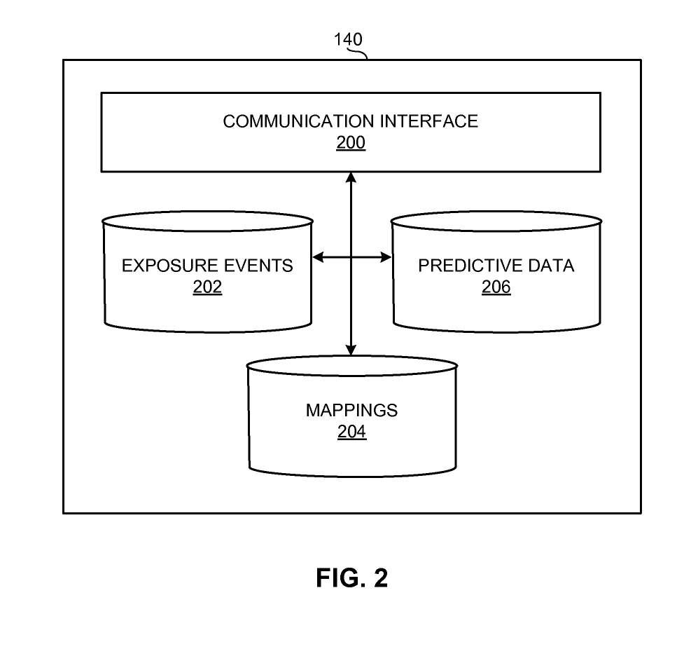

FIG. 2 is a block diagram of an example apparatus that may be used to implement the example exposure database 140 of FIG. 1. The example exposure database 140 of FIG. 2 includes a communication interface 200 to facilitate communication with the diagnosis support module 105, the clinical records manager 130, and/or any other element of the example server 100 of FIG. 1. The example communication interface 200 may also facilitate communication with devices external to the example server 100 such as, for example, machines authorized to access the databases 125 and 140 located at a library, personal computers authorized to access the databases 125 and 140 over a network, etc.

The example exposure database 140 of FIG. 2 includes an exposure events storage 202 that maintains information related to recorded actual and potential exposures to hazardous elements. For example, the exposure events storage 202 of FIG. 2 includes information related to events (e.g., industrial accidents (such as chemical spill or vapor fallout), war (such as biological warfare, nuclear attack and so on), natural calamities (such as flood, sunburn, earthquake, volcanoes, etc.), erroneous waste disposals (such as untreated effluents, medical waste etc.), etc.) during which one or more populations were exposed to materials deemed (e.g., by a panel or public health organization) hazardous to humans. Other hazardous elements to which populations may be exposed include traumatic events that are witnessed by the populations that can affect mental health of a witness. Such elements include terrorist attacks, wars, traffic accidents, murders, etc.

The content of the exposure event storage 202 may be based on, for example, a State sponsored initiative or by related professional bodies. The information in the exposure events storage 202 could be generic for centralized recording of all recordable worldly hazardous events or could be specific to different categories of worldly hazardous events. The exposure events storage 202 may reference any number of systems associated with specialized professional bodies to periodically update the contents of the exposure events storage 202.

Details of the events recorded in the exposure events storage 202 of the exposure database 140 include the hazardous elements to which people were or may have been exposed, measurements associated with the materials (e.g., volumes, densities, concentrations, etc.), date and time of the location, an epicenter of the event, a coverage area of potential exposure, duration of exposure, and/or any other suitable detail associated with the events. Moreover, the details stored in the exposure events storage 202 may include characteristics of the hazardous materials. For example, the Chemical Abstract Service based in Columbus, Ohio, associates a number to each chemical and records its properties. The example exposure events storage 202 can reference such a source and store information therefrom to assist in identifying the virulence or other characteristic of various chemicals.

The example exposure events storage 202 also includes instances of possible and actual exposure to hazardous materials untied to a specific accident or event, but rather discoveries of exposures to hazardous materials in, for example, residences, places of employment, and/or other frequently occupied areas or buildings. Such instances include, for example, a discovery that a building was constructed with high amounts of asbestos, a discovery that machinery operated without proper filtration or ventilation, etc. In such instances, the example exposure events storage 202 includes data indicative of which hazardous materials people were or may have been exposed, measurements of the materials (e.g., volumes, densities, concentrations, etc.), location of exposure, duration of exposure, etc.

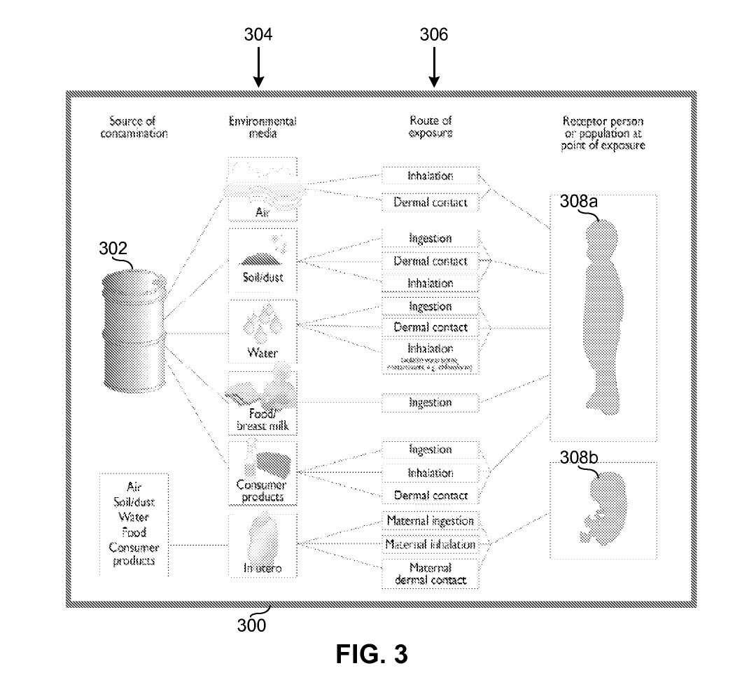

The example exposure events storage 202 also includes details related to manners in which the hazardous materials may have been transmitted to people. FIG. 3 is a diagram 300 that illustrates a plurality of example manners in which people may be exposed to hazardous materials. In particular, FIG. 3 shows that sources of contamination 302 (i.e., hazardous materials) can be communicated to people (referred to herein sometimes as receptors) via a plurality of different environmental media 304 and a plurality of different routes of exposure 306. For example, an environmental media such as air 304 can be contaminated with a hazardous material such as industrial waste 302. The industrial waste 302 is inhaled 306 directly by a receptor 308a. The inhalation 306 of the industrial waste 302 by the receptor 308a also indirectly exposes a second receptor 308b (e.g., a baby in utero) to the industrial waste 302.

The details surrounding potential or actual exposure events stored in the example exposure events storage 202 includes information similar to that of the diagram 300 of FIG. 3. For example, the exposure events storage 202 may record characteristics of the hazardous material 302 involved in the exposure event or discovery. In some example, the exposure events storage 202 also records possible and/or actual environmental media 304 to which the hazardous material 302 had contact. Further, given a certain characteristic of the hazardous material 302, the example exposure events storage 202 may store one of or more potential routes of exposure 306 through which the hazardous material 302 may be transferred to humans. For example, some hazardous materials 302 may not be capable of affecting humans via the air. In such instances, the exposure events storage 202 may indicate that despite the exposure event involving the hazardous materials, little, if any, risk was posed to human not located within a certain distance of the hazardous materials due to the incapability of the hazardous material traveling through the air at dangerous levels.

In some examples, the example exposure events storage 202 is categorized or broken down into groups of different types of potential and/or actual exposures. For example, the exposure events storage 202 can include a first partition or portion dedicated to industrial spills, a second partition or portion dedicated to nuclear radiation exposures, a third partition or portion dedicated to natural calamities, a fourth partition or portion dedicated to indoor exposures, etc. Such a breakdown enables more efficient querying and greater options to searchers of the exposure events storage 202.

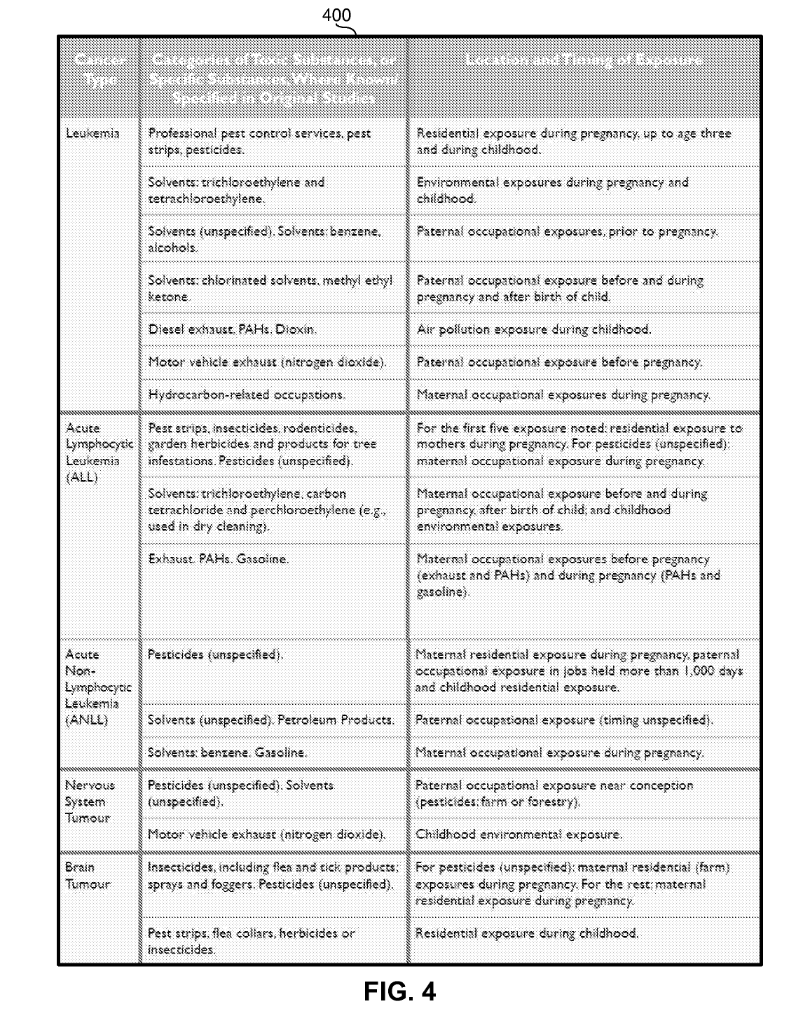

The example exposure database 140 of FIG. 2 also includes a mappings storage 204 that maintains information linking exposure to certain materials to one or more diseases or conditions that have been tied to the corresponding materials by, for example, one or more empirical studies and/or experimentations. FIG. 4 is an example table 400 that may be maintained by the example mappings storage 204 of FIG. 2. The table of FIG. 4 illustrates the links between certain types of cancer and exposure to different categories of toxic substances at different locations and timings. The information of the mappings storage 204 of FIG. 2 may include additional details such as, for example, percentages associated with likelihoods of patients developing the different types of cancers based on exposure to the different types of toxic substances. Moreover, the example mappings 204 can include one or more suggestions for a patient given exposure to certain hazardous materials, such as, for example, precautionary steps that can be taken by the patient in light of the exposure, tests that should be ordered, medications that can be prescribed in light of the exposure, etc. Further, the information of the mappings storage 204 can include links involving other types of diseases, conditions and/or ailments. For example, the mappings storage 204 can include links between stress disorders that can manifest after a traumatic events. That is, the exposure database 140 is not limited to physical exposure of people to materials. Instead, the exposure database 140 and the mappings storage 204 thereof also includes data related to the mental health of people and events that may have affected the mental health of people, such as those witnessing a terrorist attack or experiencing warfare.

The example exposure database 140 of FIG. 2 also includes a predictive data storage 206 that maintains information related to predictions made by, for example, healthcare practitioners that have utilized the data of the example exposure database 140. As described in greater detail below, the example diagnosis support module 105 enables healthcare practitioners to make such predictions based on data related exposures of populations to hazardous materials. The example predictive data storage 206 stores these predictions and data associated therewith such as, for example, notes created by the healthcare practitioner(s) making the predictions including reasons for the predictions and/or other aspects (e.g., percentages or odds) related to decisions made by the healthcare practitioner(s), treatment options presented to the patient such as, for example, medications, precautionary measures to be taken, etc. Additionally, the example predictive data storage 206 stores data related to the accuracy of the predictions. Consequently, the exposure database 140 and the predictive data storage 206 thereof can be used to improve abilities of healthcare practitioners to learn from successful and unsuccessful diagnosis and/or predictive analyses.

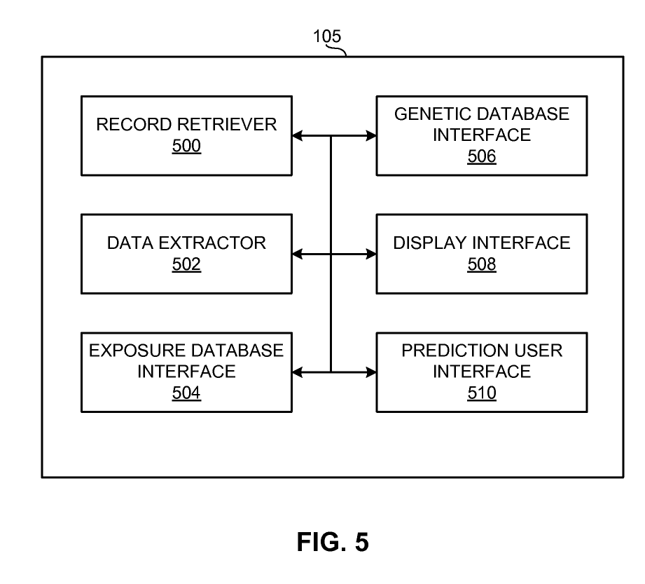

FIG. 5 illustrates an example apparatus that may be used to implement the example diagnosis support module 105 of FIG. 1. The example diagnosis support module 105 includes a record retriever 500 that interacts with the example clinical records manager 130 of FIG. 1 to obtain data related to, for example, patients registered with a healthcare information system associated with the example server 100 of FIG. 1. The example record retriever 500 of FIG. 2 can interact with additional or alternative sources of records, such as shared databases of clinical records across an XDS Affinity, an HIE, an RHIO, and/or any other system configured to facilitate sharing (e.g., registration, distribution, access, etc.) of healthcare data among the healthcare enterprises. Regardless of the source, the example record retriever 500 retrieves records related to any customizable aspects of a patient history. In the illustrated example, the record retriever 500 identifies and retrieves clinical records that include details surrounding a birth of a patient and the early years of the life of the patient. Such details may include place of birth, time and date of birth, an identification of the mother of the patient and the father of the patient, an occupation of the mother and the father of the patient, and/or any other useful information related to the patient. In the illustrated example, the record retriever 500 is aware of one or more standardizations that require documents generated according to the standards to include certain information. The example record retriever 500 recognizes such documents and retrieves the documents when the standardization thereof indicates that the documents include the details surrounding the birth of the patient and the early years of the life of the patient. For example, the record retriever 500 of FIG. 5 identifies Health Level 7 (HL7) documents and retrieves the same. The example record retriever 500 can also retrieve non-standardized documents, as HL7 documents are described herein for purposes of illustration. That is, any type of standardized and/or non-standardized documents can be utilized by the examples described herein.

The example diagnosis support module 105 also includes a data extractor 502. The example extractor 502 of FIG. 5 analyzes the clinical records (e.g., those received from, for example, the clinical records database 125 by the record retriever 502) to identify one or more aspects of patient histories corresponding to patients associated with the received clinical records. In the illustrated example, particular segments of HL7 documents retrieved by the record retriever 500 are analyzed by the data extractor 502. Table I illustrates different field sequences and HL7 attributes from which the data extractor 502 can extracted the details described herein.

TABLE I
HL7 Segments and Attributes

| Field | | | |
|---|---|---|---|
| Sequence | Type | HL7 Attribute Name | Mapped to Required Data |
| PID-7 | TS | Date/Time of Birth | Date of birth of patient |
| PID-7 | TS | Date/Time of Birth | Time of birth of patient |
| PID-23 | ST | Birth Place | Place of birth of patient |
| PID-12 | IS | Country Code | Country of birth of patient |
| PID-6 | XPN | Mother's Maiden Name | Mother's name |
| PID-21 | CX | Mother's Identifier | Mother's SSN |
| NK1-3 | CE | Relationship | Relationship with patient |
| NK1-2 | XPN | Father's Name | Father's name |
| NK1-10 to | ST | Job Title to Organization | Father's Occupation |
| NK1-13 | | | |
| NK1-37 | ST | Contact person - SSN | Father's SSN |

As Table I is included herein for illustrative purposes, the data extractor 502 can extract additional or alternative details related to a patient from additional or alternative types of documents, standardized and/or non-standardized. In other words, the details surrounding a birth of a patient, the early years of the patient, and/or a lineage of the patient, for example, can be extracted by the example data extractor 502 in any suitable manner from documents of any protocol, standard, and/or general documents. As described below, the example data extractor 502 can also perform a focused extraction of a subset of information as instructed by a user performed a focused analysis.

The example diagnosis support module 105 also includes an exposure database interface 504 for communicating with the example exposure database 140 of FIGS. 1 and/or 2. In the illustrated example of FIG. 5, the example exposure database interface 504 facilitates authorization of one or more users to gain access to the exposure database 140 of FIGS. 1 and/or 2. Further, the example exposure database interface 504 implements a plurality of different techniques or methods for devices of different types and/or devices operating according to different protocols to communicate with the example exposure database 140. As described above, the example exposure database 140 disclosed herein can be implemented as part of centralized system in a healthcare information system and/or may be shared across a plurality of healthcare information systems. The example exposure database interface 504 enables a user of the example diagnosis support module 105 to access the exposure database 140 via the plurality of implements of the exposure database 140 (e.g., across a plurality of healthcare information systems).

In the illustrated example, the exposure database interface 504 queries the example exposure database 140 with the information extracted by the example data extractor 502. As described above, the example data extractor 502 extracts information related to certain aspects of a patient history (e.g., specifics of a birth, characteristics of a pregnancy, occupational details related to a mother and/or father). In the illustrated example, the information related to these aspects is conveyed to the exposure database 140 along with at least one request for information in return. For example, the exposure database interface 504 can query the exposure database 140 with a birth date and location of birth for a patient. The exposure database 140 can return any actual or potential exposures that occurred within a threshold period of time surrounding the received birth date at the received location and/or within a threshold distance from the received location. Additionally or alternatively, the example database interface 504 can query the exposure database 140 with information related to occupation(s) of the mother and/or father of the patient. The exposure database 140 can return any actual or potential exposures that occurred at a place of employment according to the received occupational information. Additionally or alternatively, the example database interface 504 can query the exposure database 140 with information related to place of residency of the mother during pregnancy. The exposure database 140 can return any actual or potential exposures that occurred at that location according to the received location and time information.

Moreover, the example exposure database 140 may return general information from the mappings 204 related to risks associated with any actual or potential exposures found from the queries described above. In some examples, when a query of the exposure events storage 202 returns an exposure event or discovery, the exposure database 140 automatically returns such mapping information from the mappings 204 by identifying which hazardous elements formed the basis of the actual or potential exposure event or discovery and sending the corresponding mapping information to the querying device (e.g., the exposure database interface 504. In some examples, the exposure database interface 504 can submit a secondary query to the mappings 204 in response to receiving certain information from the exposure events storage 202 and/or as a standalone query.

The example diagnosis support module 105 also includes a genetic database interface 506. In the illustrated example of FIG. 5, the genetic database interface 506 queries the genetic database 145 of FIG. 1 with information extracted by the data extractor 502. For example, with reference Table I above, the data extractor 502 may extract a social security number (SSN) from field sequence PID-21 of a HL7 document associated with a patient. The SSN of the mother can be used by the genetic database interface 506 to query the genetic database 145. In some examples, the genetic database interface 506 queries additional or alternative sources of genetic information, such as the clinical records 125 of FIG. 1 and/or another database accessible the clinical records manager 130. The SSN of the mother can be used to drill down into the medical history of the mother (e.g., in the clinical records 125) to identify any possible hereditary ailments that could have an effect on the patient. Additionally, the SSN of the mother can be used to obtain a SSN of the maternal grandmother of the patient, which can similarly be used to drill down into the medical history of the grandmother to identify any possible hereditary ailments that could have an effect on the patient. This drill down approach could also be performed on the lineage of the father of the patient.

The example diagnosis support module 105 also includes a display interface 508 to communication information received from, for example, the exposure database 140 to a user of the diagnosis support module 105. The example display interface 508 of FIG. 5 conditions the data received from the exposure database 140 for display to a user via any suitable user interface. In some examples, the display interface 508 may implement such a user interface that can be processed by a plurality of different devices (e.g., web browsers on a personal computer, a smart phone, a personal digital assistant, a tablet). Additionally or alternatively, the display interface 508 may communicate the results received from the exposure database 140 to a remote address associated with the user such as, for example, an email address, an network address associated with a printer, etc.

The example diagnosis support module 105 also includes a prediction user interface 510 to enable practitioners utilizing the example diagnosis support module 105 to record diagnoses or predictive data in the predictive data 206 of the example exposure database 140. For example, when the exposure database 140 returns information indicating that a patient was or may have been exposed to certain hazardous materials, a practitioner receiving such information may base a diagnosis or a prediction of development of a condition on that exposure information (e.g., using data received from the mappings 204). The practitioner may use the exposure information alone or in combination with other factors related to the health of the patient to make a diagnosis or prediction. The diagnosis and/or prediction may also involve the practitioner prescribing certain medicines, instructing the patient to take certain precautionary measures, and/or other treatment options. The treatment options, instructions, etc. can also be stored in the predictive data 206 via the example prediction user interface 510.

While an example manner of implementing the diagnosis support module 105 of FIG. 1 has been illustrated in FIG. 5, one or more of the elements, processes and/or devices illustrated in FIG. 5 may be combined, divided, re-arranged, omitted, eliminated and/or implemented in any other way. Further, the example record retriever 500, the example data extractor 502, the example exposure database interface 504, the example display interface 506, the example prediction user interface 508, and/or, more generally, the example diagnosis support module 105 of FIG. 5 may be implemented by hardware, software, firmware and/or any combination of hardware, software and/or firmware. Thus, for example, any of the example record retriever 500, the example data extractor 502, the example exposure database interface 504, the example display interface 506, the example prediction user interface 508, and/or, more generally, the example diagnosis support module 105 of FIG. 5 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example record retriever 500, the example data extractor 502, the example exposure database interface 504, the example display interface 506, the example prediction user interface 508, and/or, more generally, the example diagnosis support module 105 of FIG. 5 are hereby expressly defined to include a tangible medium such as a memory, DVD, CD, etc., storing the software and/or firmware. Further still, the example diagnosis support module 105 of FIG. 5 may include one or more elements, processes and/or devices in addition to, or instead of, those illustrated in FIG. 5, and/or may include more than one of any or all of the illustrated elements, processes and devices.

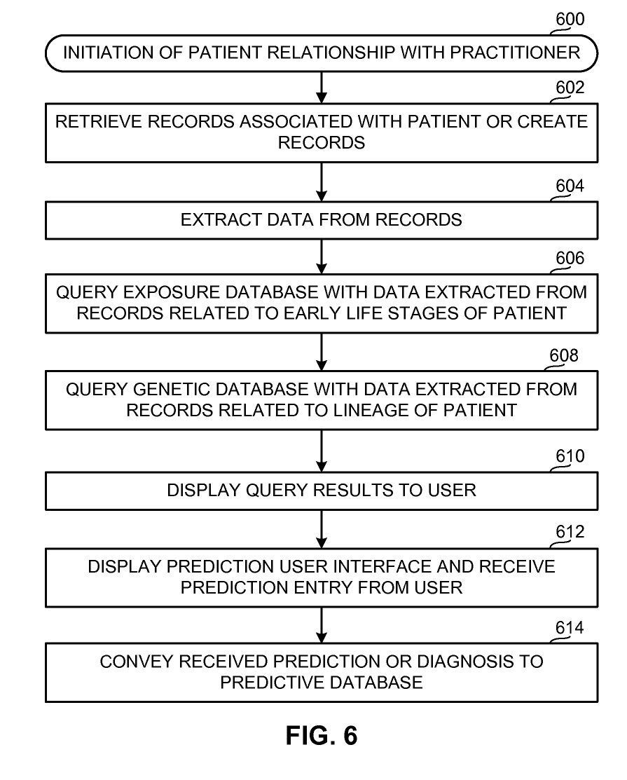

FIG. 6 is a flow diagram representative of example machine readable instructions that may be executed to implement the example diagnosis support module 105 of FIGS. 1 and/or 5. The example processes of FIG. 6 may be performed using a processor, a controller and/or any other suitable processing device. For example, the example processes of FIG. 6 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 6 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 6 may be implemented manually or as any combination(s) of any of the foregoing techniques, for example, any combination of firmware, software, discrete logic and/or hardware. Further, although the example processes of FIG. 6 are described with reference to the flow diagrams of FIG. 4, other methods of implementing the processes of FIG. 6 may be employed. For example, the order of execution of the blocks may be changed, and/or some of the blocks described may be changed, eliminated, sub-divided, or combined. Additionally, any or all of the example processes of FIG. 6 may be performed sequentially and/or in parallel by, for example, separate processing threads, processors, devices, discrete logic, circuits, etc.

Generally, the example diagnosis support module 105, in conjunction with the example exposure database 140, informs a healthcare practitioner of hazardous exposure(s) suffered or potentially suffered by a patient and the possible futuristic impact on the health of the patient, from which the healthcare practitioner may provide a proactive diagnosis for related disease(s) and/or condition(s). Additionally or alternatively, the example diagnosis support module 105, in conjunction with the example genetic database 145, informs a healthcare practitioner of hereditary ailments that may affect a patient and the possible futuristic impact on the health of the patient, from which the healthcare practitioner may provide a proactive diagnosis for related disease(s) and/or condition(s). The process(es) may be performed at any suitable time or any suitable stage of treatment. In the illustrated example of FIG. 6, the diagnosis support module 105 begins operating with respect to a patient at an initiation of a relationship with a healthcare practitioner, such as a physician (block 600). However, the diagnosis support module 105 can begin operating in response to other events such as, for example, as part of a batch processing of many patients. In the illustrated example, the diagnosis support module 105 automatically attempts to retrieve records associated with the patient upon the initialization and/or retrieves the records in response to an instruction from, for example, the healthcare practitioner (block 602). In particular, the example record retriever 500 attempts to retrieve records from the clinical records database 125. In some examples, the record retriever 500 first attempts to retrieve records generated and maintained in accordance with HL7 standardization and, if none are available, attempts to retrieve alternative types of records that are likely to include certain information (e.g., data related to early life stages of the patient and/or the pregnancy of the mother of the patient). In some examples, when appropriate records cannot be retrieved, the example record retriever 500 instructs a user thereof to obtain information (e.g., data related to the early life stages of the patient, identifying information associated with the parents of the patient, etc.). The user can create a clinical record (e.g., a HL7 record) for the patient (block 602).

The example data extractor 502 then extracts specific information from the received or created records (block 604). In the illustrated example of FIG. 6, the information listed in Table I above is extracted from the records. In some examples, additional or alternative types and/or pieces of data related to the patient is extracted from the records and/or obtained directly from additional or alternative sources. Accordingly, the example diagnosis support module 105 obtains details surrounding, for example, birth of the patient, the pregnancy of the mother of the patient, lineage of the patient, and/or other information as described above in connection with FIGS. 2 and 5. In some examples, a user of the diagnosis support module 105 may perform a more targeted analysis by instructing the diagnosis module to extract particular information from the retrieved records. The user may perform such a focused analysis in light of other information from treatment of the patient. For example, to study possible exposure to environment pollution, the user may instruct the data extractor 502 to extract a date of birth from PID-7 (see Table I) and a place of birth from PID-23 for querying the exposure database 140 and/or a portion thereof dedicated to industrial accidents for recordings of industrial accidents involving any chemical or vapor spill or untreated industrial effluent spill around the date of birth and place of birth of the patient. In another example, to study possible exposure to nuclear radiation, the user may instruct the data extractor 502 to extract a date of birth from PID-7 and a place of birth from PID-23 for querying the exposure database 140 and/or a portion thereof dedicated to nuclear incidents for recordings of nuclear accidents or biological warfare around the date of birth and place of birth of the patient. In another example, to study possible exposure to natural calamities, the user may instruct the data extractor 502 to extract a date of birth from PID-7 and a place of birth from PID-23 for querying the exposure database 140 and/or a portion thereof dedicated to natural calamities for recordings of floods, volcanoes, extreme climatic condition etc., around the date of birth and place of birth of the patient. In another example, to study possible exposure to possible indoor exposure such as the metal Lead in paint, medical waste etc., the user may instruct the data extractor 502 to extract an occupation from NK1-10 to NK1-13 of the parents of the patient. In another example, to study possible exposure to drugs used by the mother during pregnancy, the user may instruct the data extractor 502 to extract a date of birth from PID-7 and a SSN of the mother from PID-21 for querying the clinical records database 125 for any drug therapy given to the mother for any ailment suffered near the date of birth. In another example, to study possible exposure to hereditary ailments, the user may instruct the data extractor 502 to extract a SSN of the mother from PID-21 to drill down into a medical history of the mother using the SSN to query the clinical records database 125 for details of the medical history of the mother. Moreover, a medical history of a material grandmother of the patient can be accessed using the SSN of the mother. Alternatively, the data extractor 502 may be configured to extract all available data and the user can select from a listing of extracted information to query the one or more databases described herein.

The extracted data related to the early life stages of the patient (e.g., place and date and time of birth) is used to query the example exposure database 140 (block 606). The exposure database 140 compares the received data to the records thereof related to potential and/or actual exposures. If a potential and/or actual exposure event of the exposure database 140 corresponds to the details surrounding the early life stages of the patient, the exposure database 140 returns data associated with the exposure(s). The returned data includes, for example, what type of hazardous elements were involved in the exposure, the media through which a population was exposed, linkages between such exposures and certain diseases or condition from the mappings 204, likelihoods of complications, likelihoods of certain symptoms being caused by different types of exposures, etc.

The extracted data related to the lineage of the patient (e.g., a SSN of the mother and/or father) is used to query the example genetic database 145 (block 608). The genetic database 145 (e.g., via an interaction with the clinical records manager 130) uses the received data to drill down into medical histories of ancestors of the patient to identify any potential hereditary ailments that may be passed down to the patient. This information may provide a healthcare practitioner with information related to possible predispositions of the patient. If a potential hereditary ailment is found by the genetic database 145 (and/or the clinical records manager 130), the example genetic database 145 returns details regarding the hereditary ailment to the diagnosis support module 105. The returned data includes, for example, the hereditary ailment involved in the findings, likelihoods of complications arising from the hereditary ailments, potential affects, etc.

The results of the queries of the exposure database 140 and/or the genetic database 145 are displayed to a user via the display interface 508 of the example diagnosis support module 105 of FIG. 5 (block 610). As a result, the user is provided with information related to a variety of details surrounding actual and/or potential exposures that may have affected a patient. For example, the displayed information may inform the user that a patient was exposed to industrial waste when the patient was in utero by way of the mother of the patient inhaling air contaminated by the industrial waste or living near a water supply that was contaminated by the industrial waste. Alternatively, the patient may have been exposed to the industrial waste for additional periods of time when the patient was very young (e.g., one to two years old) by living on soil that was contaminated by the industrial waste. Moreover, the displayed information, via the mappings 204 of the exposure database 140, can include data regarding potential diseases and/or conditions that may have been caused or exacerbated by the specific type of industrial waste listed in the exposure database 140. In some examples, the displayed information, via the mappings 204, can include one or more symptoms that can be explained by the exposure to such industrial waste. In some examples, the mappings 204 may also return an automatically generated likelihood that certain diseases or conditions would develop in the patient due to the exposure to the industrial waste. The displayed information can also include one or more suggestions to the user regarding, for example, precautionary steps that can be taken by the patient in light of the exposure to the industrial waste, tests that should be ordered, medications that can be prescribed in light of the exposure, etc. The user, such as a physician or other healthcare practitioner, can analyze the returned results as part of a diagnosis, a screening process, and/or at any other stage of treatment.

Further, the prediction user interface 510 implements a user interface that is presented to the user (block 612). For example, the prediction user interface 510 may display such a user interface in response to selection of an option presented in association with the exposure and/or genetic results displayed via the display interface 508. As described above, a diagnosing physician and/or other type of healthcare practitioner can use the information provided via the diagnosis support module 105 to gauge one or more possibilities of the patient developing one or more conditions and/or diseases. These analyses can be entered into the user interface implemented by the prediction user interface 510. The example prediction user interface 510 receives such predictive data and conveys the same to the exposure database 140 for storage in the predictive data database 206 (block 614).

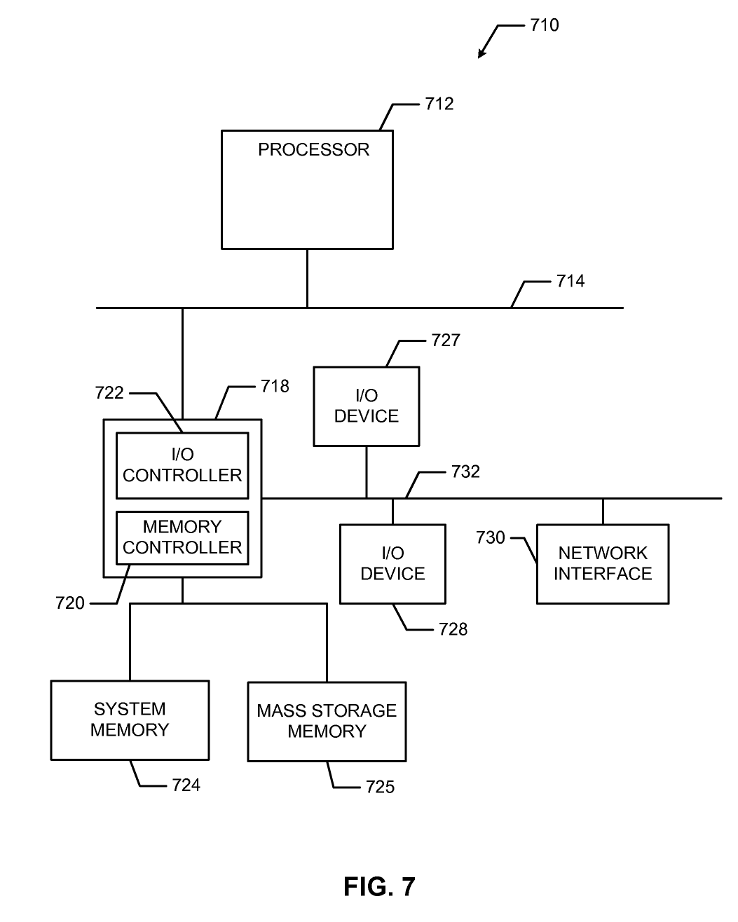

FIG. 7 is a block diagram of an example processor system 710 that may be used to implement the apparatus, methods, systems and/or articles of manufacture described herein. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. An apparatus, comprising:
a data extractor to extract information related to a life stage of a patient from clinical records associated with a patient; and
a first interface to interact with a database storing information related to a plurality of hazardous event exposures, wherein interacting with the database comprises determining whether a first one of the hazardous event exposures stored in the database corresponds to the life stage of the patient.

2. An apparatus as defined in claim 1, the first interface to receive a characteristic of the first hazardous event exposure when the first hazardous event exposure corresponds to the extracted information related to the life stage of the patient.

3. An apparatus as defined in claim 2, wherein the characteristic of the first hazardous event exposure includes an identification of a hazardous material involved in the first hazardous event exposure.

4. An apparatus as defined in claim 3, the first interface to receive data indicative of a disease linked to the hazardous material.

5. An apparatus as defined in claim 1, further comprising a prediction interface to implement a user interface to receive a prediction from a healthcare practitioner based on data related to the first hazardous event exposure.

6. An apparatus as defined in claim 1, wherein the extracted information includes a location of a birth of the patient and a date of the birth of the patient.

7. An apparatus as defined in claim 1, wherein the extracted information includes an identifier associated with a mother of the patient.

8. An apparatus as defined in claim 1, wherein the extracted information includes an occupational identifier associated with a parent of the patient.

9. An apparatus as defined in claim 1, further comprising a second interface to interact with a genetic database storing information related to hereditary ailments suffered by a plurality of patients, wherein interacting with the genetic database comprises querying the genetic database with the extracted information.

10. A computer-implemented method, comprising:
extracting information related to a life stage of a patient from clinical records associated with the patient; and
interacting with an database storing information related to a plurality of hazardous event exposure, wherein interacting with the database comprises determining whether one or more of the hazardous event exposures stored in the database corresponds to the life stage of the patient; and
when a first one of the one or more hazardous event exposures corresponds to the life stage of the patient, displaying data related to the first hazardous event exposure on a display device.

11. A method as defined in claim 10, further comprising receiving a characteristic of the first hazardous event exposure when the first hazardous event exposure corresponds to the extracted information related to the life stage of the patient.

12. A method as defined in claim 11, wherein the characteristic of the first hazardous event exposure includes an identification of a hazardous material involved in the first hazardous event exposure.

13. A method as defined in claim 12, further comprising receiving data indicative of a disease linked to the hazardous material.

14. A method as defined in claim 10, further comprising implementing a user interface to receive a prediction from a healthcare practitioner based on data related to the first hazardous event exposure.

15. A method as defined in claim 10, wherein the extracted information includes a location of a birth of the patient and a date of the birth of the patient.

16. A method as defined in claim 10, wherein the extracted information includes an identifier associated with a mother of the patient.

17. A method as defined in claim 10, wherein the extracted information includes an occupational identifier associated with a parent of the patient.

18. A method as defined in claim 10, further comprising interacting with a genetic database storing information related to hereditary ailments suffered by a plurality of patients by querying the genetic database with the extracted information.

19. A system, comprising:
an exposure database to store events including actual or potential exposure of people to elements deemed to be hazardous to the people, wherein the exposure database stores characteristics of the events;
a mappings storage to store a plurality of findings linking the hazardous elements to one or more health effects;
a module to extract data related to a life stage of a patient from clinical records associated with the patient, the module to query the exposure database using the extracted data to determine whether one or more of the exposure events corresponds to the life stage of the patient and, wherein the module is to receive one or more of the findings from the mappings storage when the query of the exposure database indicates that at least one of the exposure events corresponds to the life stage of the patient.

20. A system as defined in claim 19, further comprising a genetic database, wherein the module is to query the genetic database using the extracted information to identify hereditary ailments suffered by a person in a lineage of the patient.
